(19) United States
(12) Patent Application Publication
(10) Pub. No.: US 2006/0196955 A1
(43) Pub. Date: Sep. 7, 2006

(54) Domestic water pre-heating apparatus and method for a vehicle

(76) Inventors: Bill Moxon, Greeley, CO (US); Harold R. Enander, Hudson, CO (US)

Correspondence Address: SHERIDAN ROSS PC, 1560 BROADWAY, SUITE 1200, DENVER, CO, 80202, US

(21) Appl. No.: 11/069,105

(22) Filed: Mar. 1, 2005

(51) Int. Cl. B60H 1/22

(52) U.S. Cl. 237/34

(57) ABSTRACT

A compact vehicle heating system and method is provided which includes mechanisms to selectively shut down heating systems. For example, when domestic hot water is required, space heating and engine preheating systems can be shut down in order to provide priority heating to the domestic hot water. When the demand for domestic hot water is lower, the space heating and engine preheat systems can be reactivated. In accordance with other embodiments of the invention, a domestic water tank pre-heating system is provided to pre-heat domestic water within the domestic water tank. In accordance with still other embodiments of the invention, a water saver system is provided for limiting the wasting of clean but tepid water.

### CROSS REFERENCE TO RELATED APPLICATIONS

Cross-reference is made to U.S. patent application Ser. No. 10/841,884 filed May 6, 2004, which is a continuation of U.S. patent application Ser. No. 10/453,181 filed Jun. 2, 2003 (now U.S. Pat. No. 6,732,940), which is a continuation of U.S. patent application Ser. No. 10/027,473 filed Dec. 21, 2001 (now U.S. Pat. No. 6,572,026), which is a continuation of U.S. patent application Ser. No. 09/454,157 filed Nov. 30, 1999 (now U.S. Pat. No. 6,332,580), which claims the benefit of U.S. Provisional Patent Application No. 60/110,474 filed Nov. 30, 1998. The entire disclosures of the cross-referenced applications and patents listed above are considered to be part of the disclosure of the present application and are incorporated herein by reference.

### FIELD OF THE INVENTION

This invention relates to providing supplemental thermal energy to vehicles having living areas, and more particularly to providing supplemental heat to over-the-road and marine craft having rooms and/or domestic water to be heated. Various embodiments of the present invention include a domestic water pre-heating system and a water saver system.

### BACKGROUND

Vehicles of many types have been used to provide temporary living or working quarters. These include self-propelled over-the-road vehicles, such as so-called recreational vehicles powered by internal combustion engines. Also, self-propelled vans have been used as mobile work spaces, such as for providing medical services at remote or movable locations in a city. Other self-propelled vehicles include boats in which internal combustion engines provide the primary power source. Other non-self-propelled vehicles, such as trailers, have been used to provide shelter for temporary living, such as for vacation or recreation. Also, trailers are used to provide space for performing work, such as at construction sites or performing atmospheric sensing at remote locations.

All of these vehicles are characterized by the need to provide heated space, in the form of at least one room. In general, many separate rooms or work areas are provided. Also, sanitary facilities are provided in such vehicles, and include plumbing fixtures such as sinks, showers, and toilets that use domestic water, especially heated water.

The term “vehicle” is used herein to refer to all types of vehicles, whether or not self-propelled and whether an over-the-road or water vehicle, so long as there is a space to be heated in the vehicle and/or a requirement that heated domestic water be available for use. The term “vehicle” may also include the above type of vehicle that is also provided with a main power source, such as an internal combustion engine, that has a primary function of propelling the vehicle on land or water. Customarily, those main power sources are heated when not in operation, so that they will start readily when the vehicle is to be moved.

The main power source of such vehicle is turned off when the vehicle arrives at the destination, and reliance is placed on a supplemental source of thermal energy. Such supplemental thermal energy sources include diesel-fired and gasoline-fired burners, such as those disclosed in U.S. Pat. Nos. 2,726,042 and 3,877,639.

An improved heating system for a recreational vehicle is described in U.S. Pat. Nos. 5,025,985 and 5,067,652, both of which are incorporated herein by reference in their entirety. However, improvements are desirable. For example, it would advantageous if the heating system were compact, so as not to take up more valuable space in a vehicle than is necessary. It would be advantageous if the heating system included an efficient control system. It would be advantageous if the heating system could provide space heating and hot water heating, as well as optional engine heating if desired.

It would also be advantageous to pre-heat domestic water within the domestic water tank in order to store heat energy so that the water system will not freeze, the storage areas adjacent to the water tank will be warmed by radiant heat from the tank, and so that the vehicle's domestic water heating capability will be enhanced. More particularly, existing domestic water systems on vehicles do not include a system for capturing and utilizing available thermal energy to pre-heat water within the domestic water tank. In addition, existing domestic water systems on vehicles do not include a water saver system for re-routing tepid water back to the auxiliary heater, hot water heater, and/or the domestic water tank where it can be re-heated to a desirable hot temperature instead of allowed to flow down the drain and into the waste water holding tank. Such a water saver system would save valuable clean water and assist in limiting unnecessary filling of the vehicle's waste water tank.

### SUMMARY OF THE INVENTION

In accordance with the present invention, a heating system is provided which includes a heating medium and a first heat transfer device located within said heating medium capable of heating a fluid flowing through the first heat transfer device. Operatively connected to the input side of the first heat transfer device is a first temperature sensor. This first temperature sensor is located outside of a tank which contains the heating medium. When the fluid to be heated, such as cold water to be heated for domestic hot water use, flows through the first heat transfer device, the first temperature sensor will register a relatively low temperature because the fluid flowing past it is cold. When the first heat transfer device is not in use, the first temperature sensor will register a higher temperature, due to conduction of heat from within the tank to the nearby location of the first temperature sensor. Preferably, a second temperature sensor is also provided which measures the temperature of the heating medium within the tank. Preferably the second temperature sensor is in direct fluid contact with the heating medium within the heating tank. The heating medium can also be pumped out of the tank in order to provide heat for desired purposes, such as space heating purposes. Alternatively, a separate heat transfer fluid can be employed which passes through a second heat transfer device within the tank to obtain heat from the heating medium and to circulate it for desired purposes, such as space heating purposes. A heat source, preferably a diesel fuel-burning heat source is provided to heat the heating medium. Preferably, a tank agitation device is also provided in order to provide efficient heat transfer to the heat transfer device or devices located within the tank.

Preferably the heat tank is more compact than those provided in prior art devices such as those disclosed in U.S. Pat. Nos. 5,025,985 and 5,067,652. Preferably the tank is a rectangular box or cube as opposed to a sphere or cylinder. In this way the tank can be more efficiently placed within a vehicle and uses the space more efficiently. Preferably the tank is about one third the size of prior art tanks. Preferably the heating system uses lower temperatures and pressures than those found in prior art tanks. Preferably, an optional heating loop is provided for engine preheating. This heating loop can use the heat transfer medium directly or use a separate heat transfer medium and a heat transfer device within the heating tank. In FIGS. 4 and 5, a heat transfer device is illustrated for heating water for domestic hot water use and the heat transfer medium is used directly for space heating. The optional engine heater is also illustrated.

In accordance with the method of the present invention, a heating fluid is heated within a tank. A first heat transfer device is provided within the tank in order to heat a fluid such as water for domestic hot water use. A first temperature sensor is provided external to the tank, but near the tank on the inlet side of the first heat transfer device. A cool fluid such as cold water flows past this first temperature sensor into the heat transfer device located within the heating medium. Heat is transferred from the heating medium to the fluid flowing through the first heat transfer device which exits and can be employed, e.g., as domestic hot water within a recreational vehicle. The heating medium can also be circulated through the vehicle and in particular through heat transfer devices located within the vehicle, for space heating purposes, as illustrated in FIGS. 1, 2 and 3. It can also be employed for engine preheating. Alternatively, second and/or third heat transfer devices can be located within the heating medium to provide the heat to a circulating fluid which is employed for space heating purposes and/or engine preheating purposes. A second temperature sensor is provided to determine the temperature of the heating medium within the tank. Preferably this second temperature sensor is in fluid contact with the heating medium. Preferably a control system is provided, including temperature sensors which are preferably solid state, although mechanical controls and/or sensors can be used. The control system can be employed to selectively disable parts of the heating system.

In accordance with other embodiments of the invention, a domestic water pre-heating system is provided that comprises a domestic water tank and a means for heating water. The means for heating water is operatively interconnected to the domestic water tank. In addition, the system includes a domestic water return line between the means for heating water and the domestic water tank, wherein the domestic water return line conveys water back into the domestic water tank from the means for heating water.

In accordance with still other embodiments of the invention, a domestic water pre-heating system for a vehicle is provided that comprises a domestic water tank located within a bay of the vehicle, and a water heating mechanism in fluid communication with the domestic water tank. In addition, the system includes a domestic water return line between the water heating mechanism and the domestic water tank, wherein the domestic water return line conveys water back into the domestic water tank from the water heating mechanism.

In accordance with yet other embodiments of the invention, a method for providing a domestic water pre-heating system for a vehicle is provided, the method comprising installing a domestic water tank within a bay of the vehicle and interconnecting the domestic water tank to a means for heating water using a conduit. The method further includes interconnecting a domestic water return line between the means for heating water and the domestic water tank, wherein the domestic water return line conveys water back into the domestic water tank from the means for heating water.

In accordance with still other embodiments of the invention, a water saver system is provided that comprises a domestic water tank and a means for heating water. The means for heating water is operatively interconnected to the domestic water tank. In addition, a water saver return line is provided between a faucet in the vehicle and the means for heating water, wherein the water saver return line conveys water back from a location at or near the faucet to at least one of the domestic water tank or the means for heating water.

Various embodiments of the present invention are set forth in the attached figures and in the detailed description of the invention as provided herein and as embodied by the claims. It should be understood, however, that this Summary of the Invention may not contain all of the aspects and embodiments of the present invention, is not meant to be limiting or restrictive in any manner, and that the invention as disclosed herein is and will be understood by those of ordinary skill in the art to encompass obvious improvements and modifications thereto.

Additional advantages of the present invention will become readily apparent from the following discussion, particularly when taken together with the accompanying drawings.

### BRIEF DESCRIPTION OF THE DRAWINGS

FIG. 1 is perspective view of a vehicle provided with a heating apparatus for providing supplemental thermal energy for room air, domestic hot water and main engine heating.

FIG. 2 is a schematic illustration of an embodiment of the heating system of the present invention.

FIG. 3 is an illustration of an embodiment of the heating system of the present invention.

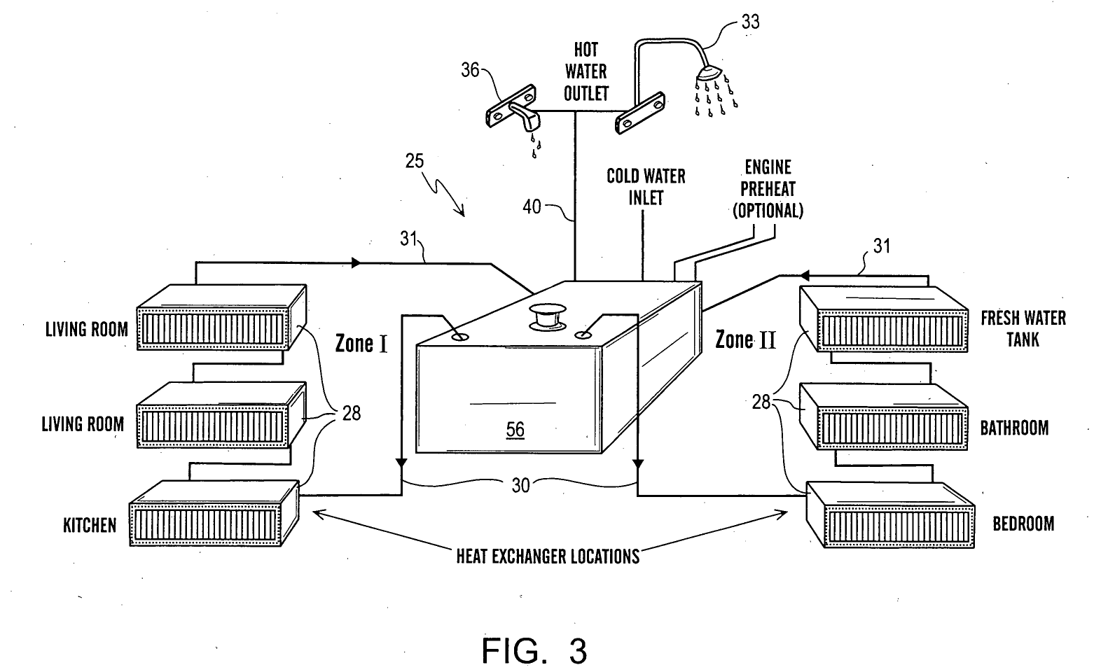

FIG. 4 is an exploded perspective view of an embodiment of a compact vehicle heating apparatus in accordance with the present invention.

FIG. 5 is another exploded perspective view of the compact vehicle heating apparatus illustrated in FIG. 4.

FIG. 6 is a perspective view of a vehicle with the heating apparatus and components shown in FIG. 1, and further including some components of a domestic water pre-heating system.

FIG. 7 is a schematic depiction of domestic water pre-heating system components that may be included in embodiments of the present invention.

FIG. 8 is a perspective view of a vehicle with hot water heater and a domestic water tank, and further including some components of a domestic water pre-heating system.

FIG. 9 is a perspective view of a vehicle with hot water heater, domestic water tank, and space heater, and further including some components of a domestic water pre-heating system.

FIG. 10 is a perspective view of a vehicle with the heating apparatus and components shown in FIG. 1, and further including some components of a domestic water pre-heating system and a water saver system.

FIG. 11 is a schematic depiction of water saver system components that may be included in embodiments of the present invention.

### DETAILED DESCRIPTION OF THE INVENTION

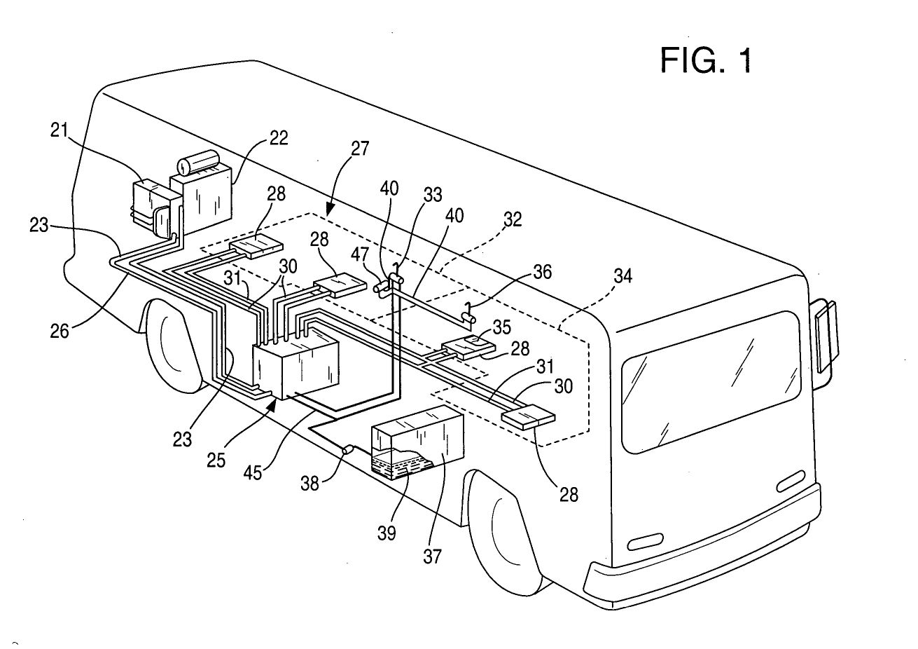

Referring to FIG. 1, there is shown a vehicle 20 that is designed to be propelled by a main engine 21. As described above, the vehicle 20 may also be in the form of a boat, in which event the main engine 21 propels the boat on the water. The vehicle 20 may also be a trailer that is towed by another self-propelled vehicle.

The main engine 21 may be an internal combustion engine or other type of engine having a liquid coolant system 22 for maintaining the main engine 21 at a desired operating temperature. Preferably, when the vehicle 20 is being propelled by the main engine 21, thermal energy is supplied via a conduit 23 that carriers heated engine coolant to an auxiliary thermal energy system 25. Cooled coolant is returned to the main engine 21 via a return conduit 26. When the main engine 21 is not operating, the main engine 21 can optionally be maintained at a desired temperature when not operating by supplying heated engine coolant from the auxiliary system 25 to the main engine 21 via the return conduit 26.

In the various forms of the vehicles, separate spaces or rooms 27 (illustrated by dashed lines in FIG. 1) can be provided for various living or working activities. In each room, at least one liquid-to-air heat exchanger 28 is provided for heating the room air to a desired temperature. These heat exchangers 28 may be of a standard type known as fan convectors. Heat transfer liquid is supplied to the heat exchangers 28 from the auxiliary system 25 by supply conduits 30 and is returned to the auxiliary system by return conduits 31.

As shown in FIG. 1, one of the rooms 27 may be a bathroom 32 that is provided with a shower head 33. Another room 27 may be a kitchen 34 provided with a sink 35 and faucet 36. The shower head 33 and the faucet 36 are connected to a standard domestic water tank 37. As shown, a pump 38 provides pressure to supply domestic water 39 from the tank 37. The domestic water 39 is heated by the auxiliary system 25 and is supplied via hot water conduits 40 to the respective shower head 33 and the faucet 36.

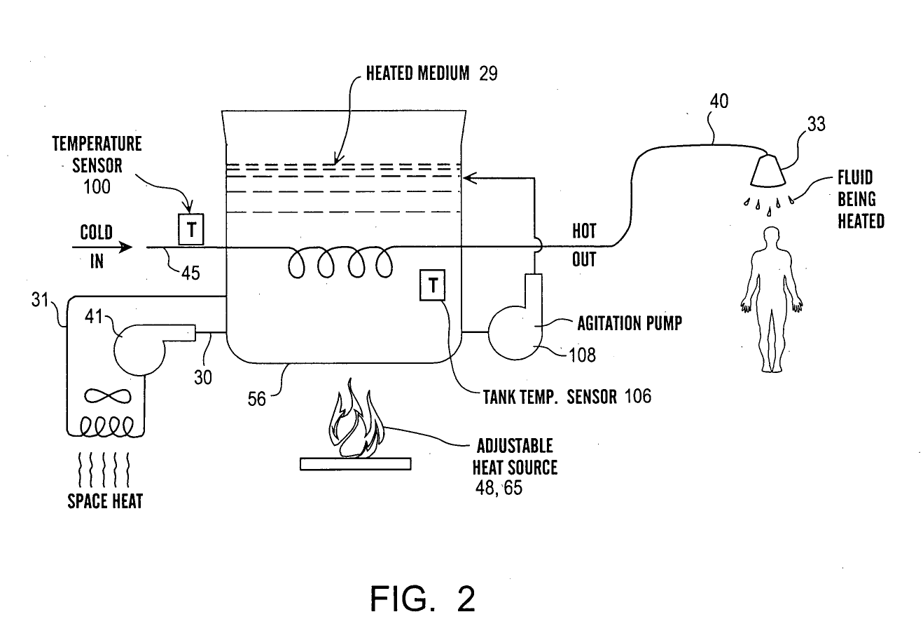

Referring to FIG. 2, the supply and return conduits 30 and 31, respectively, that are connected to the room air heat exchangers 28 are shown connected to zone pump 41. A conduit 30 supplies heated heat transfer fluid to the zone pump 41 from the auxiliary system 25. In a typical vehicle 20, a zone to be heated is defined by a room 27, and may typically have a thermal load of from 3,000 to 8,000 BTUs per hour. This load represents the thermal energy necessary to maintain the room air temperature in the room 27 at 75° F., for example, with an outside ambient temperature of from 0° to 50° F. In the aggregate, the thermal load of all of the rooms 27 of the vehicle 20 would typically be about 20,000 BTUs per hour.

Referring to FIG. 1, a cold water conduit 45 from the domestic water tank 37 is shown connected to the auxiliary system 25 to provide heated domestic water in the hot water conduit 40 that is connected to the shower head 33, a lavatory 47 and the kitchen faucet 36. A mixing valve can be used for blending hot domestic water and cold water to obtain a desired temperature of the hot domestic water exiting the system 25. The typical demand for hot domestic water 39 is about 1.5 gpm for the shower head 33, the kitchen faucet 36 and the lavatory 47 at a temperature of 105° F., for example. If the cold domestic water 39 is stored in the tank at 55° F., for example, then the thermal load of that domestic water would be about 40,000 BTU per hour.

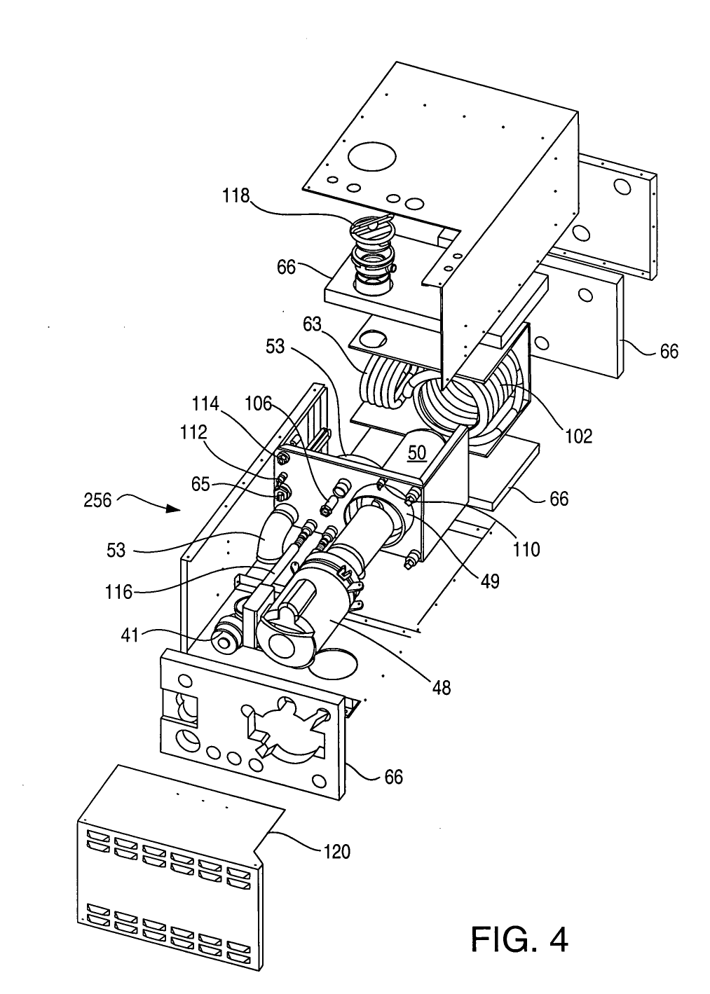

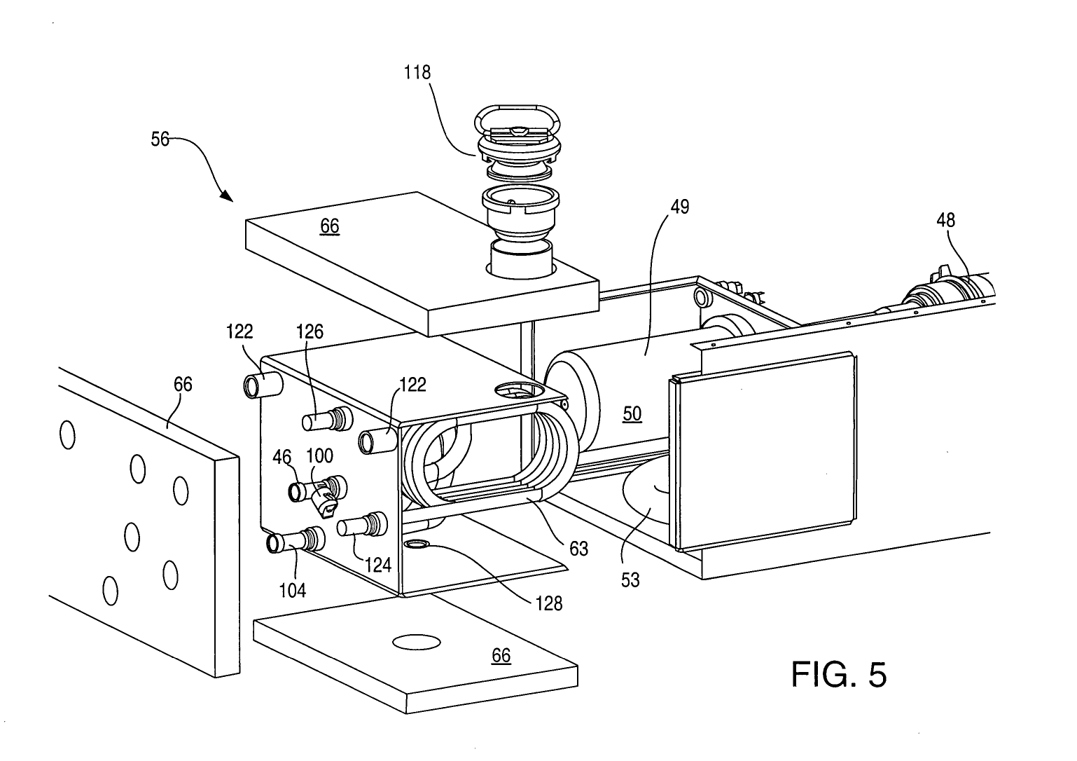

During use, when hot water is desired, cold domestic water 39 flows through conduit 45 into the inlet 46 of the first heat transfer device 102 (FIGS. 4 and 5). The fluid, e.g. the cold domestic water 39, passes the first temperature sensor 100, passes through the first heat transfer device 102 and exits the auxiliary heater 25 at the hot domestic water outlet 104. This heated fluid can be used for any appropriate purpose. While the fluid, such as domestic water, is being heated in this matter, the first temperature sensor 100 will sense the cooler temperature of the cold inlet fluid. This low sensed temperature will cause the space heater circuit to be temporarily deactivated (e.g., zone pumps 41 will be turned off) so that all the heating is directed to the heating of this cold inlet fluid. This cold inlet fluid can draw down the temperature of the heating medium 29 quickly, because the first heat transfer device 102 located within the tank typically has a high heat transfer capacity and the tank 59 typically has a low volume. For example, the first heat transfer device 102 can be about 20 to about 40 linear feet of coiled copper. It will be appreciated that any appropriate heat transfer device (e.g., tubular, plates, etc.) can be employed.

In accordance with embodiments of the present invention, the first temperature sensor may be set at a relatively low temperature. For example, the first temperature sensor can be set at about 100° F. When the temperature reaches or falls below 100° F., the other heating circuits (e.g., space heating and/or engine heating) are deactivated. Any suitable temperature sensor can be used for the first temperature sensor 100. For example, a suitable temperature sensor is a mechanical snap disk manufactured by Elmwood Sensors. The mechanical snap disk is preset at a desired temperature, e.g., 100° F. When the temperature reaches or falls below the preset temperature, a disk pops out which electrically deactivates other heating circuits. For example, when the disk pops out, an electrical circuit can be broken thus turning off the zone pumps 41 and the engine preheat pump (not shown). Other suitable deactivation devices and techniques can also be employed. In this way, all the heat from the auxiliary heater 25 is directed to the desired primary heat system, e.g., domestic hot water. The second tank temperature sensor 106 is employed to start and stop the fuel-fired burner 48 and/or electric heater 65. For example, when the second tank heat sensor 106 detects a temperature below a certain set point (e.g., about 165° F.), the fuel-fired burner 48 and/or electric heater 65 are activated. The heaters 48 and/or 65 remain activated until a preset temperature is reached, e.g., about 180° F.

Alternatively, as cold fluid is heated by the heating medium 29, the second temperature sensor 106 can be designed to register a decreasing heating medium 29 temperature. Because heat is being removed from the heating medium 29 in a rapid fashion, the control system can be designed to start the heating cycle, using the heat source 48 and/or 65, quicker than normal. For example, when the combination of the first temperature sensor 100 is registering a cool temperature because cold water is flowing by it and the second tank temperature sensor 106 is registering a dropping value for the temperature of the heating medium 29 within the tank, the heat source 48 can be programmed to come on at a higher temperature, e.g., 175° F. instead of 165° F., because the control system is programmed to recognize that heat is being withdrawn from the heating medium in a rapid fashion. The second temperature sensor 106 can be designed to provide information on the rate of temperature decrease in order to fine tune when the heat source 48 and/or 65 should come on.

When cold water is not flowing into the first heat transfer device 102, the first temperature sensor 100 will register a higher temperature. This is because the heating medium 29 will transfer heat to the tubing and fluid of the first heat transfer device 102 which will be conducted backwards through the inlet 46 to the first temperature sensor 100. When this sensor 100 registers a temperature above a predetermined temperature, the space heater and/or engine preheater will be allowed to operate. Additionally, the heat source does not have to come on until the second tank temperature sensor reaches a lower predetermined temperature, because the space heater and/or engine preheater typically do not remove heat from the heating medium 29 as rapidly as does the first heat transfer device 102. In this way, the control system can accurately and dependably control the heating of the heating medium 102 using a desirable long heating cycle and using more infrequent heating cycles, thus reducing maintenance and conserving energy. Preferably the method of the present invention includes an agitation step wherein the heating medium is moved from one portion of the tank to another portion in order to improve the efficiency of the heat transfer. For example, as illustrated in FIG. 2, an agitation pump 108 can circulate the heated medium 29 from near the bottom of tank 56 to near the top of tank 56. For low heating loads, an agitation pump may not be needed.

To supply the thermal load of room air heat exchangers 28 and the domestic hot water 39, a vehicle 20 such as a “recreational vehicle,” for example, is provided with the auxiliary system 25 having a peak thermal output of about 45,000 BTU per hour. The auxiliary system 25 may include a propane, gasoline or diesel-fired burner 48 (FIGS. 4 and 5). In a preferred embodiment, the burner 48 is a Model DBW 2010 burner manufactured by Webasto AG having a thermal output of 45,000 BTU/hr. Such a burner 48 is normally shipped with a combustion chamber 49 (FIGS. 4 and 5) in the form of a closed horizontal cylinder 50 having an air/fuel inlet at one end and an exhaust pipe 53 at the other end. The combustion chamber 49 of the burner 48 is typically about twelve inches long and has an outer diameter of about six inches.

FIGS. 4 and 5 illustrate preferred embodiments of the thermal reservoir 56 of the auxiliary heating system 25 of the present invention. In particular, FIGS. 4 and 5 are exploded perspective views of the thermal reservoir 56 shown from opposite ends. In FIG. 4, a burner 48 is shown. Preferably, this burner is diesel-fuel fired, although other fuels (e.g., kerosene, gasoline, propane, etc.) can be employed. The burner 48 includes a combustion chamber 49 which is defined by a cylindrical cover 50. A second, optional, heat source can be provided, such as an electric heater 65. The operation of the burner 48 and electric heater 65 can be controlled by a thermostat 106. This thermostat or second tank heat sensor 106 is designed to turn on the burner 48 and/or electric heater 65 when the temperature of the heating medium 29 falls below a desired value (e.g., 165° F.) and to shut off the burner 48 and electric heater 65 when the temperature of the heating medium 29 rises above a desired temperature (e.g., 180° F.). An over-temperature sensor 110 is provided for the burner 48 and an over-temperature sensor 112 is provided for the electric heater 65. These two sensors will shut down the burner 48 and electric heater 65, respectively, if an over-temperature is reached (e.g., 230° F.). This provides a back-up safety feature to prevent overheating. A low-water cutoff switch 114 is provided to shut down operation of the unit in the event that the heating medium 29 falls below a minimum level. This is yet another safety feature.

The combustion products from the burner 48 can be exhausted through exhaust pipe 53. Preferably, a portion of the exhaust pipe 53 passes through the heating medium 29 in order to extract waste heat from the exhaust.

One zone pump 41 is shown, along with the corresponding pump supply conduit 116. Typically, there would be a pump supply conduit 116 and zone pump 41 for each heating zone desired. The pump 41 draws heating medium 29 directly out of the thermal reservoir 56 for circulation through the vehicle 20 for space heating purposes. An engine heat transfer coil 63 is provided to preheat an engine in one mode of operation and to provide a source of heat to the heating medium 29 when the engine is operating in the reverse mode of operation. A domestic hot water heat exchanger 102 is provided for heating domestic water. The reservoir 56 is surrounded by various insulation panels 66 and covers (e.g., access cover 120). When assembled, a fluid-tight tank is provided for the heating medium 29.

FIG. 5 illustrates the perspective exploded view of the apparatus of FIG. 4 from the opposite end. A cold water inlet 46 is provided which will connect to domestic water conduit 45. As cold water flows through the inlet 46 and past the first heat sensor 100, the temperature of the heat sensor will fall below a preset point (e.g., 100° F.). When the temperature falls below the preset point, the other heating systems (e.g., space heating and engine preheating) are deactivated. As a result, the thermal energy in the heating medium 29 is concentrated on the domestic hot water. Although the first heat sensor 100 can be used to shut down all other heating systems, it can also be used more selectively. For example, the sensor 100, in combination with the second tank heat sensor 106, can be used to selectively shut down other heating systems in a desired priority. For example, the engine preheat system could be shut down first, and space heating zones could be shut down one at a time until the proper balance between continuous domestic hot water heat requirement and other heat requirements are reached. In this way, some of the space heating zones can be operated simultaneously with the domestic hot water heat system. As will be appreciated by one skilled in the art, the present invention can be employed when heating systems other than engine preheat, space heating zones and domestic hot water heat are employed.

As the water flows from the inlet 46 through the domestic hot water coil 102 and out the hot water outlet 104, it is heated. Preferably, the domestic hot water coil 102 is a double wall coil. This is a safety feature, in view of the fact that the heating medium 29 preferably contains an antifreeze (e.g., ethylene glycol) and it is desirable to keep the domestic water from being contaminated by any antifreeze. A double wall coil 102 reduces the chances of contamination.

FIG. 5 also illustrates the space heat return ports 122. Typically there is a return port 122 for each zone. The return ports are connected to the return space heat conduits 31. The engine heat transfer coil 63 is operatively connected to inlet port 124 and outlet port 126. Engine coil inlet port 124 is connected to conduit 23 (FIG. 1) and outlet port 126 is connected to conduit 26 (FIG. 1). A tank fill and pressure cap 118 is provided for introducing heating medium 29 into the tank and a tank drain 128 is provided for draining fluid from the tank.

The thermal reservoir 56 of the present invention is connected to the auxiliary system 25 in three ways. First, the conduits 30 are connected to the zone pumps 41 or zone valves. The pump supply conduits 116 supply the heated liquid 29 to each of the zone pumps 41 or zone valves. A selected one or more of the pumps 41 or zone valves is operated to supply the heated liquid 29 to the heat exchanger 28 in the zone or room 27, such as the kitchen 34 to which the supply conduit 30 is connected. The liquid 29 exits the heat exchanger 28 and returns via the return conduit 31 to space heat return ports.

Second, the domestic water 39 is supplied from the domestic water tank 37 by the pump 38. The cold water conduit or pipe 45 is connected to the pump 38 and supplied cold domestic water 39 (e.g., at 55° F.) to an inlet 46 (FIG. 5) of a coil 102 located in the thermal reservoir 56. The coil 102 is secured, such by brazing, in a serpentine path or in a circular path (FIGS. 4 and 5) within the thermal reservoir 56 so that the domestic water 39 in the coil 102 is in heat transfer relationship with the liquid 29 in the thermal reservoir 56. The pump 38 causes the domestic water 39 to flow through the coil 102 to the hot water line or conduit 40 that supplies the domestic hot water to the kitchen faucet 36, the shower head 33, the lavatory 47, etc.

Third, the respective vehicle engine supply and return conduits 23 and 26 are connected to a respective coil 63 (FIGS. 4 and 5) and an engine coolant pump (not shown). The pump causes the engine coolant to flow through the heat exchange coil 63 that extends through the liquid 29 in the thermal reservoir 56 and to the return conduit 26 to the main engine 21. If the main engine 21 is to be heated, the liquid 29 is in a desired range, e.g., from 150° F. to 180° F. If the liquid 29 in the thermal reservoir 56 is to be heated during operation of the main engine 21, the coolant 24 is at a higher temperature than that of the liquid 29 in the thermal reservoir 56, such as 180° F.

The auxiliary system 25 of the present invention is also provided with an electric heater 65 (FIGS. 4 and 5) to maintain the liquid 29 in the thermal reservoir 56 in a ready condition at the upper or maximum operating temperature, e.g., 180° F. Preferably, the electric heater 65 has a rated capacity of 1650 Watts at 120 volts AC. A standard AC generator or power supply (not shown) is provided for supplying power to the heater 65.

Referring to FIG. 4, the reservoir 56 is shown provided with second tank heat sensor or thermostat 106. The thermostat 106 extends into the heat transfer liquid 29 in the reservoir 56 for response to the temperature of the liquid 29. The thermostat 106 may be an analog or digital thermostat which responds to the temperature of the liquid 29 by operating a circuit. The circuit is connected to the burner 48 and electric heater 65. When the circuit is open, the burner 48 and electric heater 65 shut off. In the example described above, the temperature at which the thermostat 106 opens the respective circuits is 180° F.

The thermostat 106 can also be set to close the respective circuits in response to the liquid 29 having the lower limit temperature. In the example described above, where the lower temperature is 165° F., the thermostat 106 for the burner 48 and electric heater 65 closes the circuit in response to a temperature of 165° F. of the liquid 29. In this manner, when the temperature of the liquid 29 drops to 165° F., then the burner 48 and electric heater 65 are turned on and the temperature of the liquid 29 is increased to 180° F. during the operational cycle. The automatic, thermostat controlled operation of the burner 48 and electric heater can be manually overridden. For example, if an operator desired to rely solely on the burner 48, the electric heater 65 could be manually turned off. As a result, only the burner 48 would cycle on and off in response to the thermostat. Likewise, the burner 48 can be manually turned off and all heat supplied by the electrical heater during low demand periods.

Many advantages of the present invention can result from locating a first temperature sensor on the cold water supply line into the boiler/water heater. This sensor is very close to the boiler wall so it will be hot any time water is not flowing through the pipe, cooling it. When water is being used, the first sensor is cold. When water is not being used, the first sensor is hot. The signal from this sensor can be either analog or digital.

Heating systems can benefit from the use of a first heat sensor by providing hot water as the first priority and space heating as the second priority. In one embodiment of the invention, the heater is smaller, less expensive and provides quality thermal comfort compared to prior designs. The signal from the first temperature sensor is used to disable space heat when the sensor detects water flow for hot water use. This is desirable because hot water requires lots of heat immediately and is used for relatively short periods. Space heating can be turned off for short periods and normally the space will remain comfortable. The heating system can be smaller since it can separately provide heat for space heating or domestic hot water, but does not have to provide heat for both at the same time.

In another embodiment of the present invention, heating system performance can be improved by agitating the fluid to enhance heat transfer. The signal from the first temperature sensor can additionally be used to turn on a source of heat exchanger agitation. Hot water requires a lot of heat immediately and agitating the fluid in the heat exchanger provides it with a smaller size exchanger. In the present invention, this agitation is preferably provided by a pump that pumps fluid from the bottom of the tank to the top, thereby causing the hot fluid to circulate rapidly around the piping (heat exchanger) carrying the fluid that is being heated.

Heaters that turn heat sources on and off or increase or decrease the heat supply often react slowly, causing over- or under-heating. A signal from the first temperature sensor combined with the tank temperature signal will provide more information than a tank temperature sensor alone. This information will enable a controller to anticipate an over- or under-heating condition and effect the adjustment of the heat source sooner, without causing a short heating cycle. When the information from this sensor is combined with similar temperature signals from the boiler tank sensor, a characteristic pattern can be identified by a smart controller before the over- or under-heating condition happens.

The signals from the first temperature sensor and the tank temperature sensor can provide information to allow reduction of over- or under-heating without decreasing the length of the burn cycle. Fuel-burning heaters often require some minimum cycle time in order to ignite, burn and extinguish safely. This is called one burn cycle. The post burn period must be long enough to clear any residual combustibles from the burn chamber before it tries to re-ignite. This is to prevent a back-fire at initial ignition. The burn time must be long enough for the burn chamber to get hot enough to clear itself of any unburned material such as fuel, smoke or soot often caused during startup. Of course, heat is not delivered until the fire is ignited and has burned long enough to heat its immediate surroundings. This is why the burn cycle must be started earlier than non-combustion heat sources and must run for a minimum length of time without overheating before it is allowed to turn off. The present combination of sensors, sensor locations and controls can achieve the desired results.

The heating system of the present invention combines a continuous supply of domestic hot water as well as interior heating into one space-savings device, and can provide one or more of the following advantages. Domestic water is heated on demand as it is being used, thus there is no need for a separate water heater. Low-velocity heat exchangers can provide quiet interior heating. Temperatures can be controlled in separate (e.g., 5) heating areas independently. Domestic hot water and interior heating can be combined in one compact unit. The compact size frees up storage space. The heater can provide uniform, draft-free heating; no hot and cold air pockets. The heater provides safety features such as automatic shut-down in case of low voltage or overheat, and it can burn low-volatility diesel fuel. The AC powered electric heating element can provide heating and domestic hot water during low demand periods. The burner can use the vehicle's on-board diesel fuel, thus there is no need for propane to supply heat. The unit can provide low diesel fuel usage and low electrical DC power consumption.

In a preferred embodiment, the vehicle heating apparatus of the present invention has the following technical specifications:

| | |
|---|---|
| Diesel-burner voltage/power consumption | 12 volts, 60 watts |
| Diesel-burner heat output | 45,000 BTU/hr. |
| Fuel type | Diesel #1, #2, or Kerosene |
| Diesel-burner fuel consumption | 0.35 gal/hr |
| Electric heating element | 120 volt/AC, 1650 watts |
| Circulating pumps | (2) 12 volt DC, 21 watts |
| Number of heating zones | maximum of 5, |
| | plus engine heat loop |
| Domestic water heating capacity | Continuous/ |
| | On-Demand |
| Dimensions | 12″ H × 18.5″ W × 30″ L |
| Weight | approximately 105 lb. |

In accordance with other embodiments of the present invention, a domestic water tank pre-heating system is provided. The domestic water tank pre-heating system allows the domestic water 39 held in the domestic water tank 37 to be partially pre-heated in order to take advantage of available thermal energy to pre-heat or raise the temperature of the domestic water 39. More particularly, domestic water 39 can be heated to raise the temperature of the domestic water 39 up to a moderate temperature that allows for faster future heating of the water, and yet remains cool enough for drinking and/or mixing with hot water at a faucet or showerhead within the vehicle 20. In addition, the domestic water tank pre-heating system offers the advantage of providing a heat source to the domestic water tank 37, pump 38 and conduits 45 to prevent freezing of these structures when temperatures are sufficiently cold. Furthermore, by providing pre-heated domestic water to the domestic water tank 37, radiant heat will be generated by the tank 37, thereby providing additional heating to spaces and structures surrounding the tank 37. Accordingly, the domestic water tank pre-heating system can reduce the heat requirements to a bay heat exchanger, and/or eliminate the need for a bay heat exchanger in the vicinity of the domestic water tank 37, water pump 38, conduits 45, and other water system structures, such as valves and fittings.

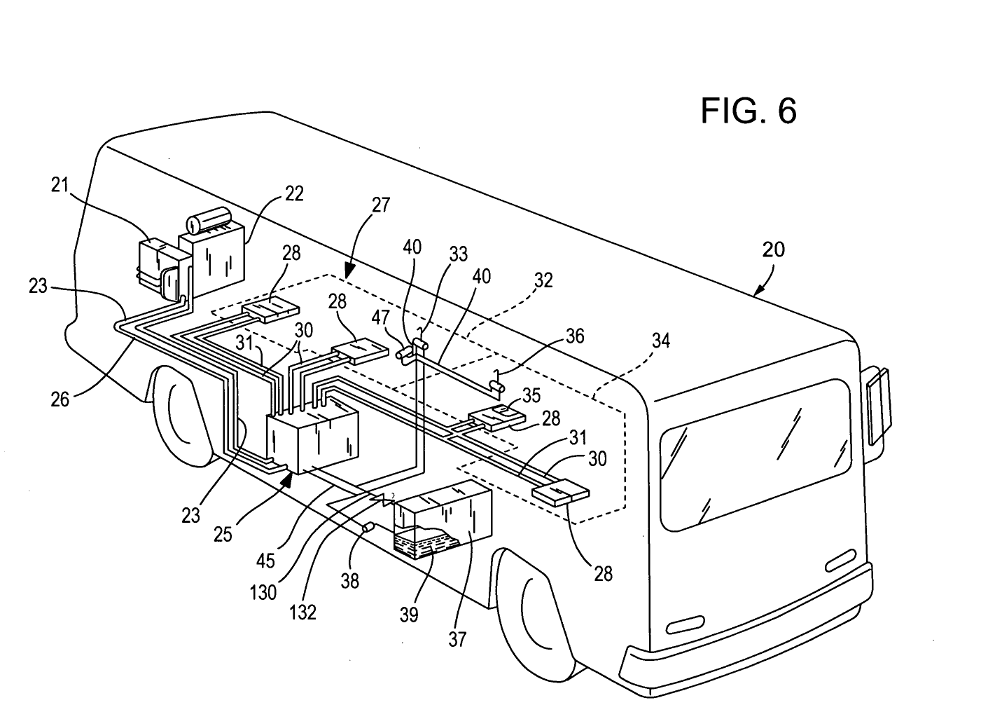

As shown in FIG. 6, in accordance with one embodiment of the present invention, the domestic water tank pre-heating system preferably includes a domestic water return line 130 and a valve 132 between the auxiliary heater 25 and the domestic water tank 37. The domestic water return line 130 conveys heated domestic water back to the domestic water tank 37. The valve 132 can be opened or closed to allow or prevent, respectively, the flow of heated water through the domestic water return line 130 to the domestic water tank 37.

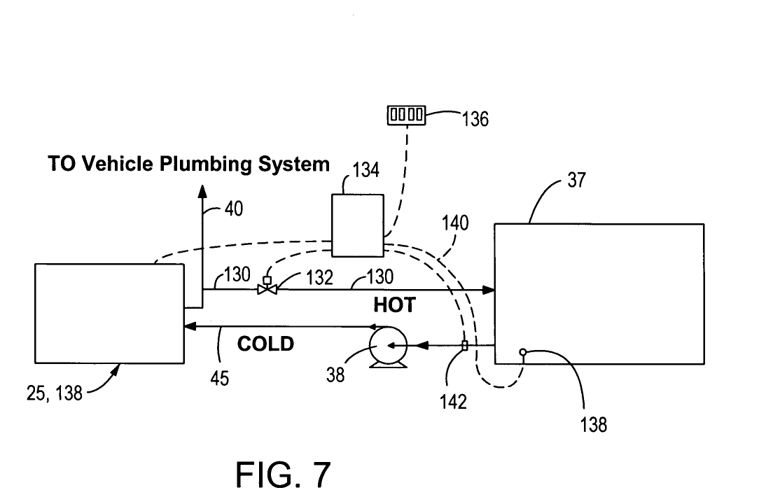

Referring now to FIG. 7, in accordance with embodiments of the present invention, the domestic water pre-heating system also preferably includes an electronic controller 134. The electronic controller 134 allows a user of the system to switch on the pre-heating process from a switch panel 136. Preferably, the electronic controller 134 only allows circulation and pre-heating of the domestic water 39 in the domestic water tank 37 if there is no immediate demand for either interior heating or hot domestic water within the vehicle 20. Therefore, if there is a demand for heated space or for heating hot water, the electronic controller 134 recognizes the thermal energy requirements on the heating system and at least temporarily prevents flow back into the domestic water tank 37 by closing valve 132.

In accordance with embodiments of the present invention, the valve 132 comprises a solenoid valve. Alternatively, the valve 132 may be controlled by air pressure, or the valve 132 may comprise a built-in thermal compensated control valve. For a solenoid valve, the electronic controller 134 is thereby able to open or close the valve 132 using an electronic signal. The valve 132 is preferably positioned between the domestic water heat exchanger and the domestic water tank 37. For the preferred embodiment of the auxiliary heater 25 depicted in FIG. 5, the valve 132 can be positioned between the coil 102 and the domestic water tank 37. The valve 132 would remain closed when there is a thermal energy demand on the auxiliary heater 25, but would preferably open to allow a return flow of domestic water 39 into the domestic water tank 37 when there is available thermal energy. The return flow of pre-heated domestic water would then mix with the existing domestic water 39 in the domestic water tank 37, thereby raising the temperature of the domestic water 39 that is residing in the domestic water tank 37.

If there is available thermal energy from previous cycling of the auxiliary heater 25, the valve 132 would preferably remain open until either there is an emerging thermal demand on the auxiliary heater 25, or until the temperature of the domestic water 39 residing within the domestic water tank 37 has risen to a maximum desired factory preset or user selectable pre-heated temperature. The pre-heated temperature is expected to be between about 40 and 70° F., and more preferably between about 50 and 60° F., and more preferably yet about 55° F., where the maximum temperature of the domestic water 39 within the domestic water storage tank 37 can preferably be selected by the user. It is expected that some users will prefer a lower temperature setting for the domestic water 39 residing in the domestic water tank 37, while conversely, other users will prefer a higher temperature setting. Accordingly, as noted, the switch panel 136 allows the user to select a preferred temperature setting. The electronic controller 134 receives the preferred temperature setting from the switch panel 136. In addition, the electronic controller 134 preferably receives temperature information from a separate temperature sensor 138 placed in the domestic water 39 of the domestic water tank 37, or within a conduit 45 carrying flow from the domestic water tank 37. The temperature sensor 138 includes a means for relaying the temperature information back to the electrical controller board 134, where such means for relaying includes wiring 140 and/or a wireless radio signal. The electrical controller board 134 then opens or closes the valve 132 as necessary to control the flow of heated domestic water to the domestic water tank 37.

The domestic water tank pre-heating system may also be used when temperatures are sufficiently cold that freezing of the domestic water tank 37 becomes a concern. Accordingly, temperature sensor 138 within the domestic water tank 37 may be used for this purpose. Alternatively, a separate temperature sensor 142 may be placed in the vicinity of the domestic water tank 37. Pre-heating of the domestic water 39 may be performed when the temperature sensed by one or more of these sensors 138, 142 is low enough to warrant preheating of the domestic water 39 within the domestic water tank 37 to avoid freezing of the domestic water tank 37, pump 38, and conduits 45.

Depending upon the heating loads, the domestic water tank pre-heating system may replace a bay heat exchanger and bay thermostat, wherein the bay 144 is the area within which the domestic water tank 37 resides. The bay 144 would be protected from freezing by the radiant heat in the domestic water tank 37 and the moderately warm water that is circulated through the pump 38 and the conduits 45, 130.

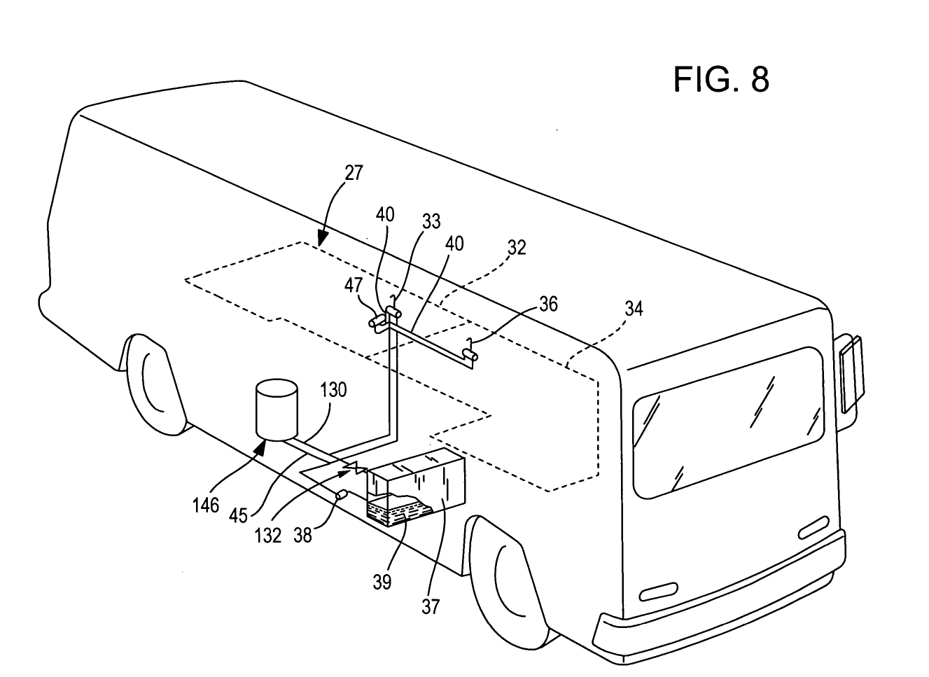

Referring now to FIG. 8, in accordance with other embodiments of the present invention, the domestic water pre-heating system also has application to relatively simple or basic water heating systems used in a vehicle, trailer or boat. By way of example and not limitation, an example of a basic water heating system can include components such as a domestic water tank 37 and a hot water heater 146. For this relatively basic water system a domestic water pre-heating system can be provided, wherein the pre-heating system includes a domestic water return line 130 and a valve 132 between the hot water heater 146 and the domestic water tank 37. The system would function as described above, wherein the domestic water return line 130 carries heated water back to the domestic water tank 37 if the valve 132 is open.

In addition, the domestic water pre-heating system as applied to a basic hot water heater 146 also preferably includes an electronic controller 134. As described above, the electronic controller 134 allows a user of the system to switch on the pre-heating process from a switch panel 136. When utilized with a basic hot water heater 146 and domestic water storage tank 37, the domestic water pre-heating system allows available thermal energy to be transferred from the hot water heater 146 to the domestic water tank 37.

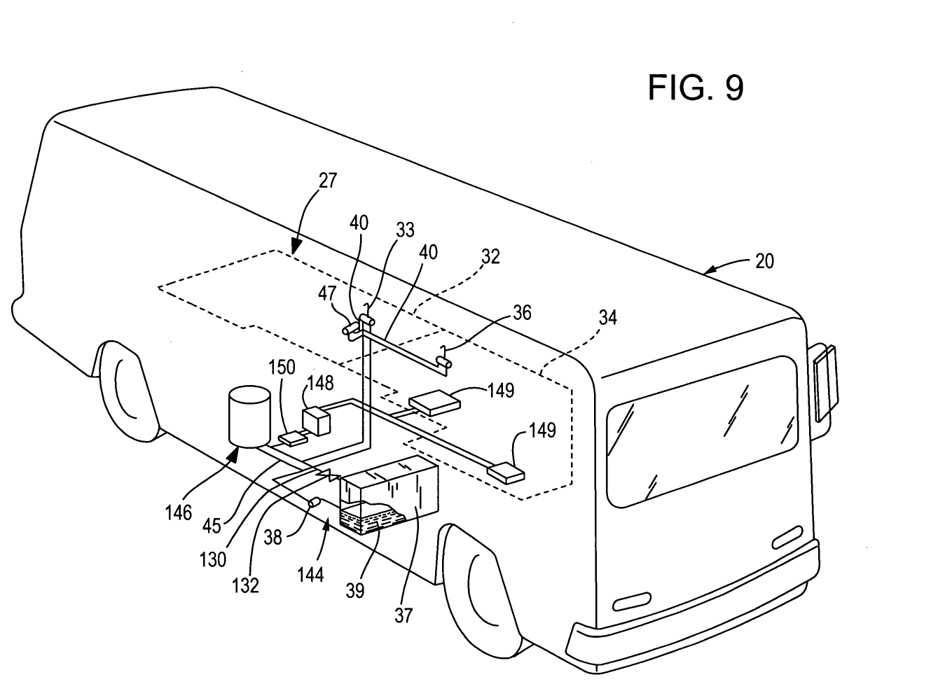

Referring now to FIG. 9, in accordance with other embodiments of the present invention, the domestic water pre-heating system is applied to a vehicle 20 that includes a space heater 148, such as an electric or propane heater. The space heater 148 forces heated air to vents 149 within the vehicle. For this configuration, a heat exchanger 150 may be included for transferring thermal energy from the space heater 148 to the domestic water 39. Accordingly, a pump 38 can be provided to convey domestic water 39 through the heat exchanger 150 and back into the domestic water tank 37, thereby providing a means of at least partially heating the domestic water 39 within the domestic water tank 37. As shown in FIG. 9, the system preferably includes a separate hot water heater 146 for providing hot water. If desired, both the hot water heater 146 and the space heater 148 can be configured to provide pre-heating of the domestic water 39.

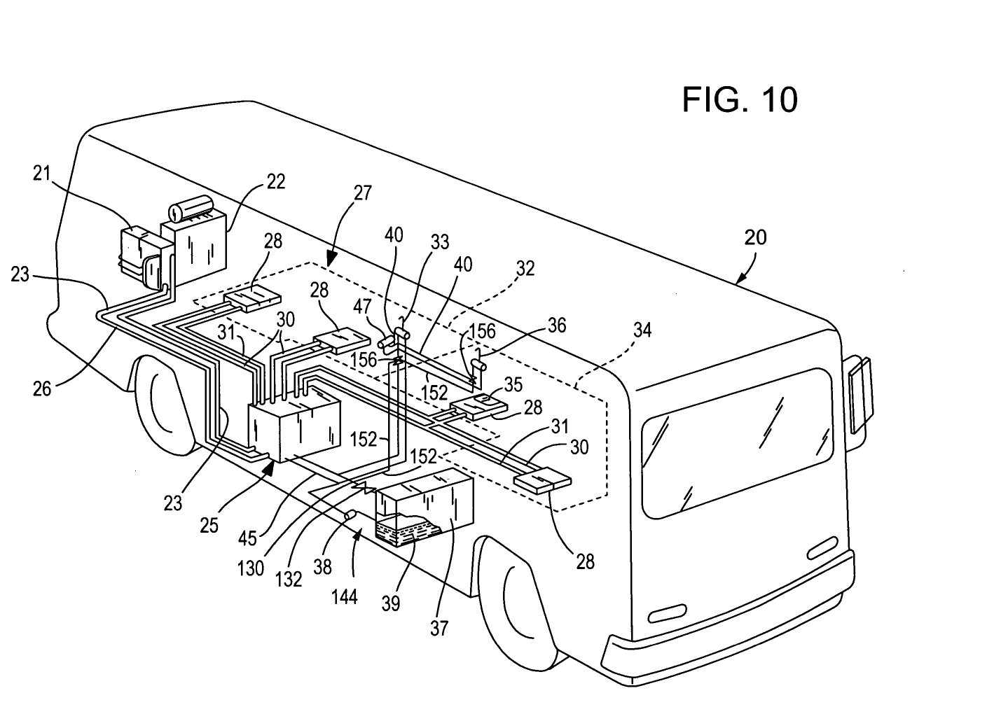

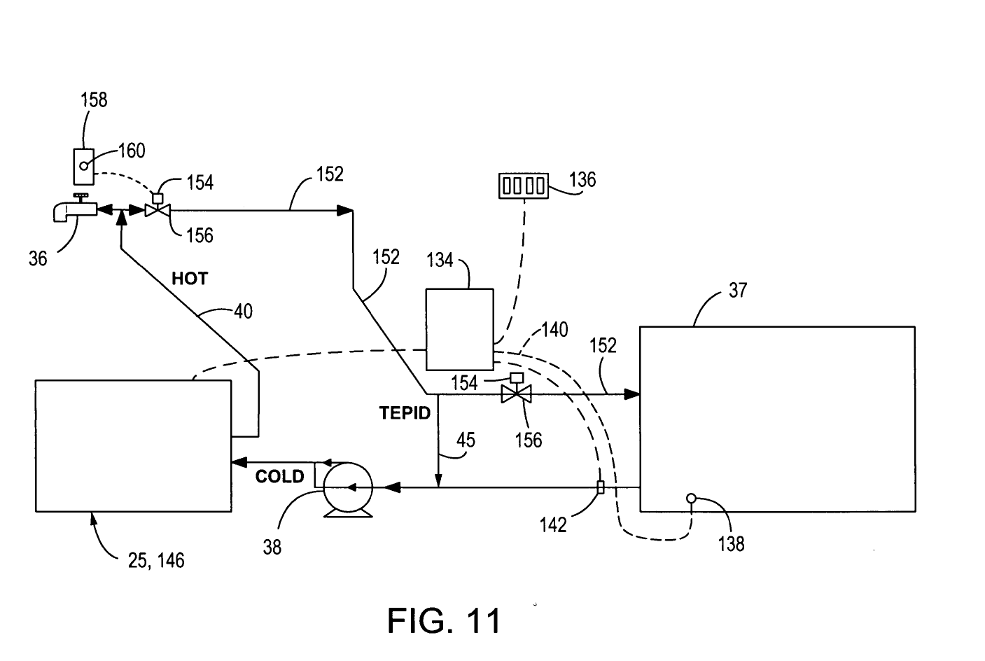

In accordance with other embodiments of the present invention, a water saver system is provided as part of the vehicle's plumbing system. Referring now to FIGS. 10 and 11, the water saver system includes a water saver return line 152, a temperature sensor 154 and a diversion valve 156. The temperature sensor 154 is preferably positioned in the vicinity of a faucet 36 or shower head 33 and senses the temperature of the water within the hot water conduit 40 near the faucet 36 or shower head 33. If the temperature is too low per a preselected temperature setting, the water is diverted from the faucet 36 or shower head 33 and sent back through the water saver return line 152 to the auxiliary heater 25, hot water heater 138, and/or the domestic water tank 37.

An additional temperature sensor 154 and diversion valve 156 are preferably situated before the domestic water tank 37 to prevent flow of water into the domestic water tank 37 if there is a demand for hot water, such that the tepid water in the water saver return line 152 can be most efficiently and expeditiously re-heated to the desired hot water temperature. Consistent with the description above of the domestic water pre-heating system, the tepid water in the water saver return line 152 can be allowed to flow to the domestic water tank 37 if the temperature of the domestic water 39 residing in the domestic water tank 37 is not at or above the desired temperature for the cold domestic water. Should the domestic water 39 residing in the domestic water tank 37 be at or above the desired temperature for the cold domestic water, then the tepid water is re-routed directly into the auxiliary heater 25 or hot water heater 146, as may be applicable.

In accordance with other embodiments of the invention, as shown in FIGS. 10 and 11, the water saver system may include an adjustable water diversion control panel 158, wherein the user can activate the water diversion control panel 158 to provide a limited diversion of water within the hot water conduit 40 to return to the domestic water tank 37 via the water saver return line 152. For example, the water diversion control panel 158 may include a timing setting that allows the user to activate the water diversion control panel 158, such as by pressing a button switch 160, that then diverts water within the hot water conduit 40 and returns the water to the auxiliary heater 25, hot water heater 146, and/or the domestic water tank 37 for between about 5 to 120 seconds, where the length of time is preferably selectable by the user.

The water saver system offers the advantage of conserving the limited supply of clean water that is held in the domestic water tank 37, while also preventing the addition of clean, albeit tepid water to the vehicle's waste water tank (not shown). The water saver system can be used in combination with the heating and water plumbing systems shown in FIGS. 1, 6, 9, and 11, as well as other systems not illustrated but known to those skilled in the art.

A number of patents in the prior art pertain to certain components of a water saver system. Accordingly, U.S. Pat. Nos. 5,572,985; 5,829,475; and 6,536,464; and U.S. Patent Application Publication No. 20030140966 are incorporated herein by reference in their entirety.

While the preferred embodiments have been described in order to illustrate the fundamental aspects of the present invention, it should be understood that numerous variations and modifications may be made to these embodiments without departing from the teachings and concepts of the present invention. Accordingly, it should be clearly understood that the form of the present invention described above and shown in the accompanying drawings is illustrative only and is not intended to limit the scope of the invention to less than that described in the following claims and as limited by the prior art.

What is claimed is:

1. A domestic water pre-heating system for a vehicle, comprising:
a) a domestic water tank;
b) means for heating water, said means for heating water operatively interconnected to said domestic water tank; and
c) a domestic water return line between said means for heating water and said domestic water tank, wherein said domestic water return line conveys a heated domestic water back into the domestic water tank from said means for heating water.

2. The system as claimed in claim 1, further comprising a first temperature sensor interconnected to at least one of (i) said domestic water tank for sensing a temperature of a tank domestic water in said domestic water tank, and (ii) a domestic water conduit flowing from said domestic water tank to said means for heating water for sensing a temperature of an exiting domestic water exiting said domestic water tank.

3. The system as claimed in claim 2, further comprising a means for controlling interconnected to said first temperature sensor, said means for controlling receiving a temperature data from said first temperature sensor.

4. The system as claimed in claim 3, wherein said means for controlling comprises an electronic controller communicating with said first temperature sensor.

5. The system as claimed in claim 3, further comprising a valve interconnected to said domestic water return line, said means for controlling communicating with a means for activating said valve.

6. The system as claimed in claim 5, further comprising a switch interconnected to said means for controlling, said switch including a temperature setting for opening and closing said valve.

7. The system as claimed in claim 1, wherein said means for heating water comprises a hot water heater.

8. The system as claimed in claim 7, further comprising a space heater operatively interconnected to said hot water heater.

9. The system as claimed in claim 1, wherein said means for heating water comprises an auxiliary heater.

10. The system as claimed in claim 9, wherein said auxiliary heater comprises:
a) a heating medium;
b) a heat source capable of being cycled for heating said heating medium;
c) first heat transfer means for transferring heat from said heating medium to a domestic water line;
d) second heat transfer means for transferring heat from said heating medium to a confined space; and
e) a second temperature sensor for sensing a temperature of said domestic water line, said second temperature sensor located external to, but near an inlet to said first heat transfer means;
f) wherein said means for controlling is operatively interconnected to said second temperature sensor to control said second heat transfer means and the cycling of said heat source.

11. The system as claimed in claim 1, further comprising a water saver system comprising a water saver return line between a faucet and said means for heating water.

12. The system as claimed in claim 11, wherein said water saver system further comprises a means for timing the return flow of a water through said water saver return line.

13. A domestic water pre-heating system for a vehicle, comprising:
a) a domestic water tank located within a bay of the vehicle;
b) a water heating mechanism in fluid communication with said domestic water tank; and
c) a domestic water return line between said water heating mechanism and said domestic water tank, wherein said domestic water return line conveys water back into the domestic water tank from said water heating mechanism.

14. The system as claimed in claim 13, wherein said water heating mechanism comprises a hot water heater.

15. The system as claimed in claim 13, wherein said water heating mechanism comprises an auxiliary heater.

16. The system as claimed in claim 13, further comprising a water saver system comprising a water saver return line between a faucet and said water heating mechanism.

17. The system as claimed in claim 16, wherein said water saver system further comprises a means for timing the return flow of a water through said water saver return line.

18. A method for providing a domestic water pre-heating system for a vehicle, comprising:
a) installing a domestic water tank within a bay of the vehicle;
b) interconnecting the domestic water tank to a means for heating water using a conduit; and
c) interconnecting a domestic water return line between said means for heating water and said domestic water tank, wherein said domestic water return line conveys water back into the domestic water tank from said means for heating water.

19. The method as claimed in claim 18, further comprising interconnecting a water saver return line between a faucet and said means for heating water.

20. A domestic water system for a vehicle, comprising:
a) a domestic water tank;
b) means for heating water, said means for heating water operatively interconnected to said domestic water tank; and
c) a water saver return line between a faucet in the vehicle and said means for heating water, wherein said water saver return line conveys water back from a location at or near said faucet to at least one of said domestic water tank or said means for heating water.
